(19) United States
(12) Patent Application Publication
(10) Pub. No.: US 2017/0125917 A1
(43) Pub. Date: May 4, 2017

(54) ANTENNA DEVICE AND ITS DIPOLE ELEMENT WITH GROUP OF LOADING METAL PATCHES

(71) Applicant: Wha Yu Industrial Co., Ltd., Hsinchu City (TW)

(72) Inventors: Hung-Hsuan LIN, Hsinchu City (TW); Ming-Yu LEE, Hsinchu City (TW)

(73) Assignee: Wha Yu Industrial Co., Ltd., Hsinchu City (TW)

(21) Appl. No.: 14/929,943

(22) Filed: Nov. 2, 2015

(51) Int. Cl. H01Q 21/06; H01Q 19/10; H01Q 5/385; H01Q 9/16

(52) U.S. Cl. CPC H01Q 21/06; H01Q 9/16; H01Q 19/108; H01Q 5/385

(57) ABSTRACT

Disclosed is an antenna device of dipole element with a group of loading metal patches, that includes: a reflector plate; at least one antenna array unit distributed and arranged on the reflector plate; at least one dipole element with group of loading metal patches configured on the reflector plate, spaced from the antenna array unit; said dipole element mainly has the following features: at least one dielectric substrate; at least one resonant arm, configured on the upper section of the dielectric substrate, said resonant arm being in a laterally extending form, having a first side and a second side; at least one continuous metal strip, configured on the first side of the resonant arm; at least one group of loading metal patches, configured on the second side of the resonant arm, having a plurality of load metal patches.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an antenna structure, and more particularly to structural and technical innovations of an antenna device of dipole element with a group of loading metal patches.

2. Description of Related Art Including Information Disclosed Under 37 CFR 1.97 and 37 CFR 1.98.

To meet the requirements of relative standards and high-density multi-band signal transmission and reception, the structural designs of antenna products have evolved from simple single antenna structures to complex integrated antenna structures, which, for example, include dual-band and multi-band base station antenna products.

In said antenna structures for dual-band and multi-band, due to the arrangement of multiple high-frequency radiators and low-frequency radiators, and limited by the product sizes, the high-frequency radiators and low-frequency radiators are distributed in close-packed arrays. As a result, in operation, the field energies of the radiators may interfere with or exert influence upon each other, leading to problems of field pattern distortion and deviation in the overall antenna radiation. Because of this, it is very difficult to enhance the effectiveness and quality of such antenna products.

In the structures of existing antenna products, some designs of shielding structures can be adopted to reduce the interference with the antenna field patterns. However, the existing shielding structures are usually in the form of full-area shielding (with respect to the configuration area of the antenna radiation part). Although this form can realize the shielding effect, there is also a serious impact on the antenna radiation property. Hence, such products are naturally associated with problems and shortcomings due to the inability to maintain normal antenna radiation properties.

Moreover, in the structures of existing antenna products, as the low-frequency radiators are closely packed with the high-frequency radiators, and the thinner and shorter are the resonant arms of the low-frequency radiators, the less interference with the high-frequency field patterns they will cause. However, too thin and too short resonant arms will relatively diminish the bandwidth and efficiency of the low-frequency radiators.

Thus, to overcome the aforementioned problems of the prior art, it would be an advancement if the art to provide an improved structure that can significantly improve the efficacy.

Therefore, the inventor has provided the present invention after deliberate design and evaluation based on years of experience in the production, development and design of related products.

### BRIEF SUMMARY OF THE INVENTION

The “antenna device and dipole element with group of loading metal patches” disclosed in the present invention provides an innovative and unique design, technically characterized by the constitution of the dipole element with innovative structural and technical innovations that include a dielectric substrate, an resonant arm, a continuous metal strip, and a group of loading metal patches. Based on the above innovations, the present invention surpasses the prior art in that it can compensate the radiation property of the low-frequency radiator of the relatively thin and short resonant arm through the group of loading metal patches, and its sectional distribution can cause the high-frequency induced current to be sectional and discontinuous, and thereby reduce the interference with and impact on the high-frequency antenna field pattern, and consequently substantially enhance the effectiveness and quality of the antenna. In addition, the plane structural design of the dielectric substrate, resonant arm, continuous metal strip, and group of loading metal patches of the dipole element disclosed in the present invention enables easy production with double-sided printed-circuit boards, which have advantages of easy adjustment, light weight and small size. The technical features of the present invention are particularly suitable for dual-band or multi-band base station antenna products.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of a preferred embodiment of an antenna device of the present invention.

FIG. 2 is a perspective view of another embodiment of an antenna device of the present invention.

FIG. 3 is a perspective view of a preferred embodiment of a dipole element of the present invention.

FIG. 4 is a perspective view of the other side of a preferred embodiment of a dipole element of the present invention.

FIG. 5 is a combined perspective view of another embodiment of a dipole element of the present invention.

FIG. 6 is an exploded perspective view of another embodiment of a dipole element of the present invention.

FIG. 7 is Plane Side View One of another embodiment of a dipole element of the present invention.

FIG. 8 is Plane Side View Two of another embodiment of a dipole element of the present invention.

FIG. 9 is an implementation view of the present invention with the continuous metal strip and loading metal patch being arranged in a plurality.

FIG. 10 is an implementation view of the present invention with the resonant arm arranged horizontally.

### DETAILED DESCRIPTION OF THE INVENTION

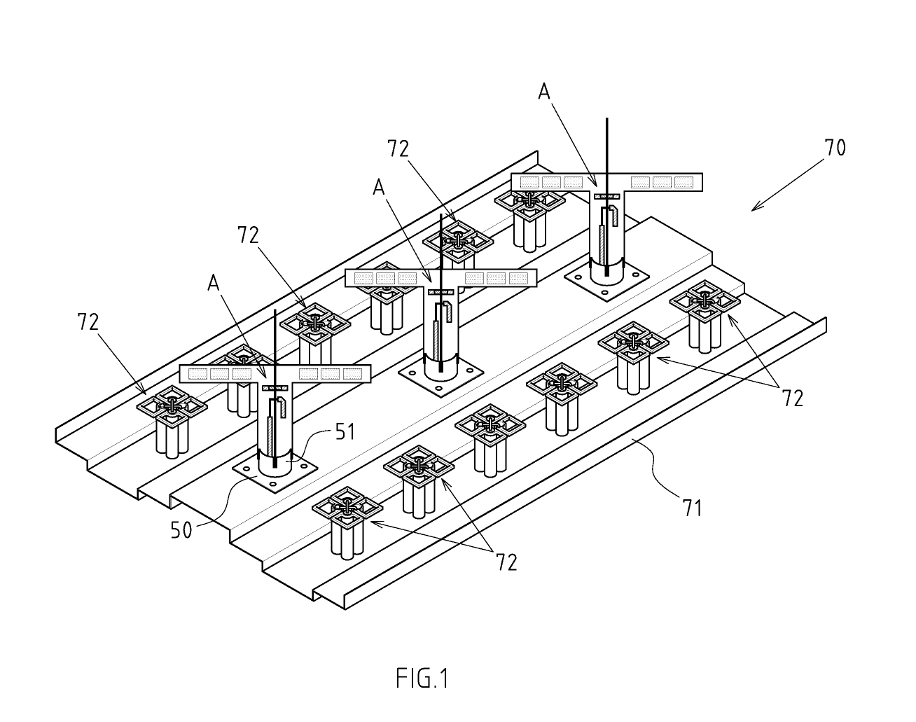

Referring to FIG. 1, the antenna device 70 disclosed by the present invention comprises: a reflector plate 71; at least one antenna array unit 72 distributed and arranged on the reflector plate 71; and at least one a dipole element with a group of loading metal patches A, configured on the reflector plate 71, spaced from the antenna array unit 72.

The present invention can be a dual-band or multi-band array antenna, and correspondingly the antenna array unit 72 is a high-frequency array and is arranged in at least two spaced columns, while the dipole element A, could be one element of a low-frequency array, and is configured between two columns of the antenna array unit 72.

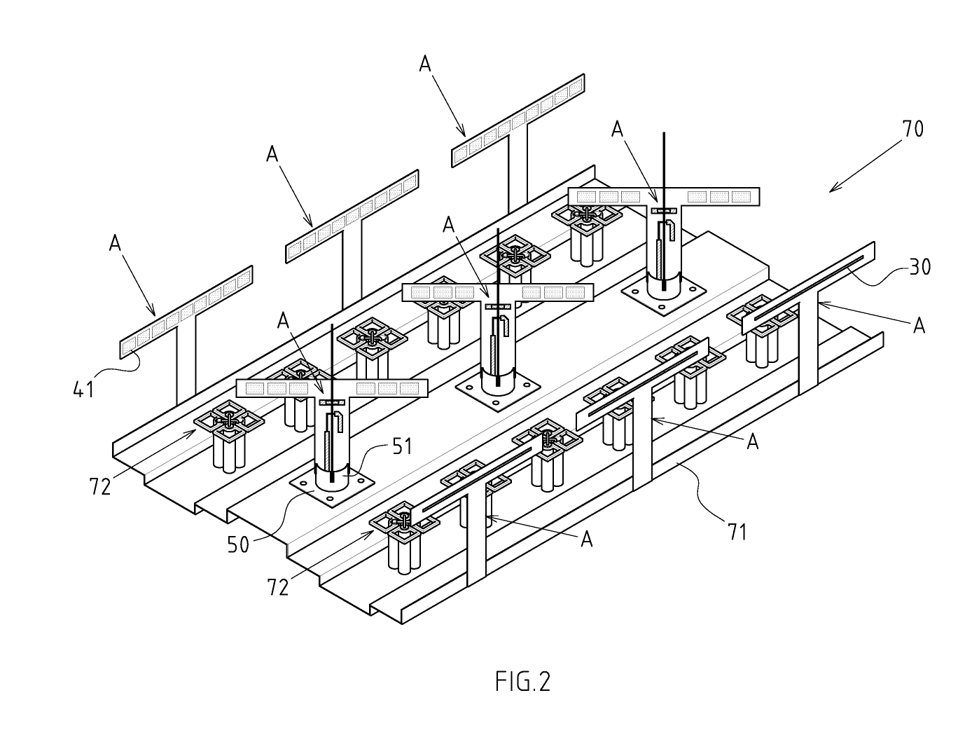

Also, as shown in FIG. 2, the dipole element A can be separately arranged between two columns of the antenna array unit 72 and on the two relative side positions.

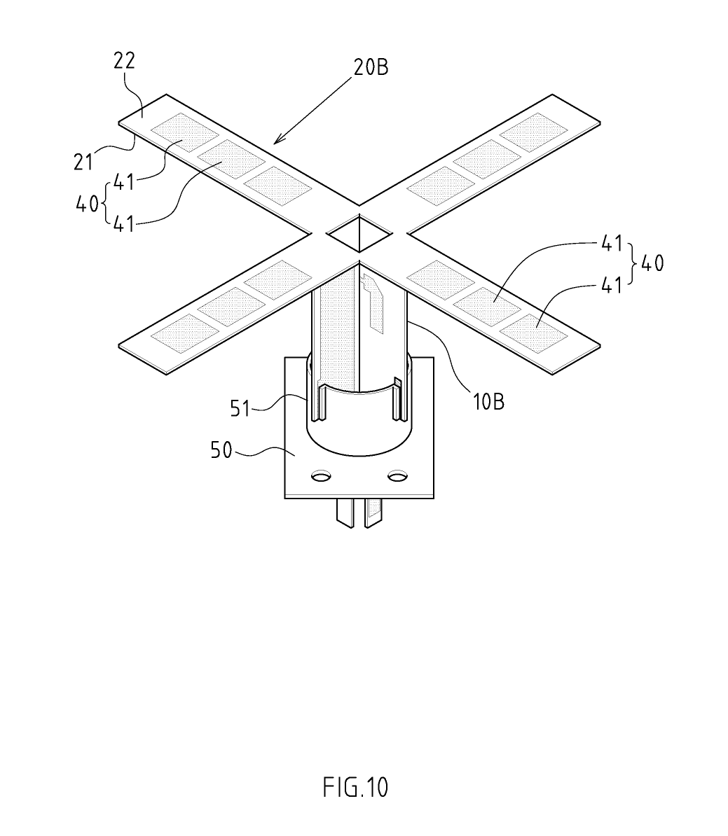

In essence, the embodiments depicted in FIGS. 1 and 2 are complex antenna devices 70 with a structure integrating two high-frequency arrays and one low-frequency array. The two high-frequency arrays are respectively arranged with 6 elements, arranged in spaced parallel on the two sides, while in the middle is a low-frequency array of dipole element A with 3 elements, each array being of dual polarization elements, therefore, in total there are 6 ports. The overall size of the antenna device 70 is actually very small, and the low frequency and high frequency arrays share the same reflector plate 71. Because the low frequency and high frequency arrays share the same reflector plate 71, considering the high-frequency field pattern, there is no way to extend a high side wall from the reflector plate 71 to control the horizontal beam width of the low-frequency, so an extra field pattern controlling structure is needed to narrow the horizontal beam width of the low frequency. This part is, as shown in FIG. 10, single-plate dipole element A arranged on the two sides of the reflector plate 71, to realize the field pattern controlling function. The dipole element A arranged here can use a metal strip for short circuit or connect to a capacitor or meandering metal wire to reduce the length, forming a source-free passive dipole reflection structure, to effectively control the field pattern deformation or distortion of the high frequency.

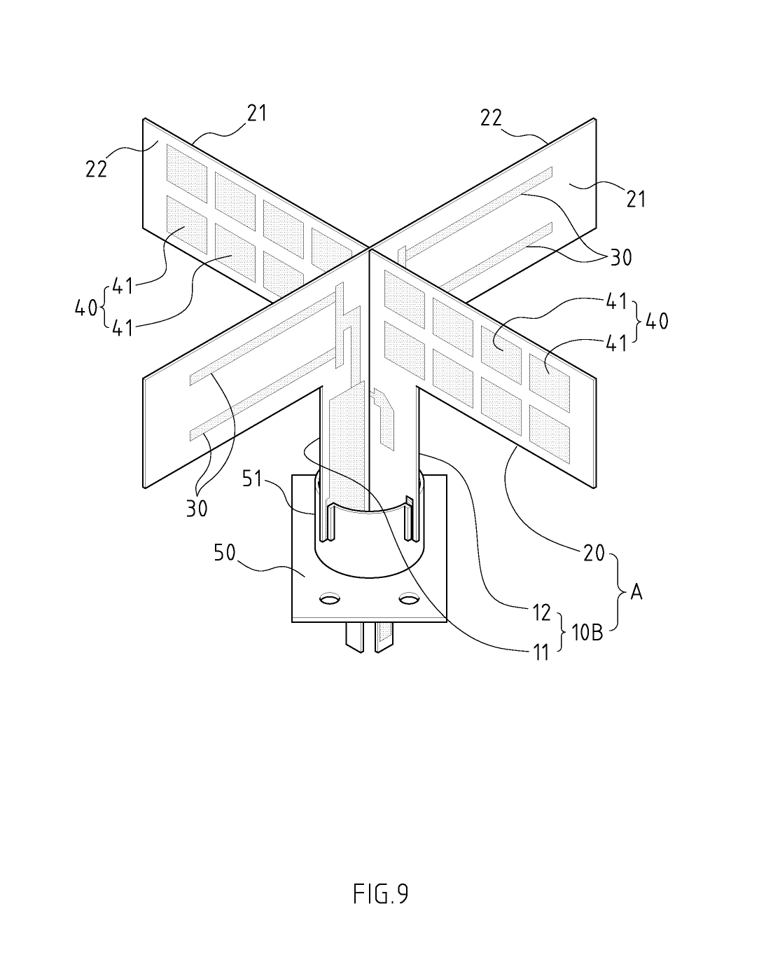

Referring to FIGS. 5 and 8, the lower section of the dielectric substrate 10B can be further arranged with a balun 60, and the lower end of the balun 60 is electrically connected with a feed-in line 61 (can be an coaxial cable or other forms of transmission cable, to form an array or be connected to other radio frequency components).

It should be noted that the continuous metal strip 30 and the loading metal patch 41 of the group of loading metal patches 40 can be connected through a via to change its impedance for optimal matching. However, in the case of feeding high power to the dipole element A, if the via is made by standard PCB Plated Through Hole (PTH), it should be noted that the linearity may become poor. In such cases, the via can be realized through welding a solid metal rod. Furthermore, on the balance end of the balun 60 or between the two resonant arms, a bridging capacitor can be configured to reduce the length of the resonant arm, or to improve the impedance matching.

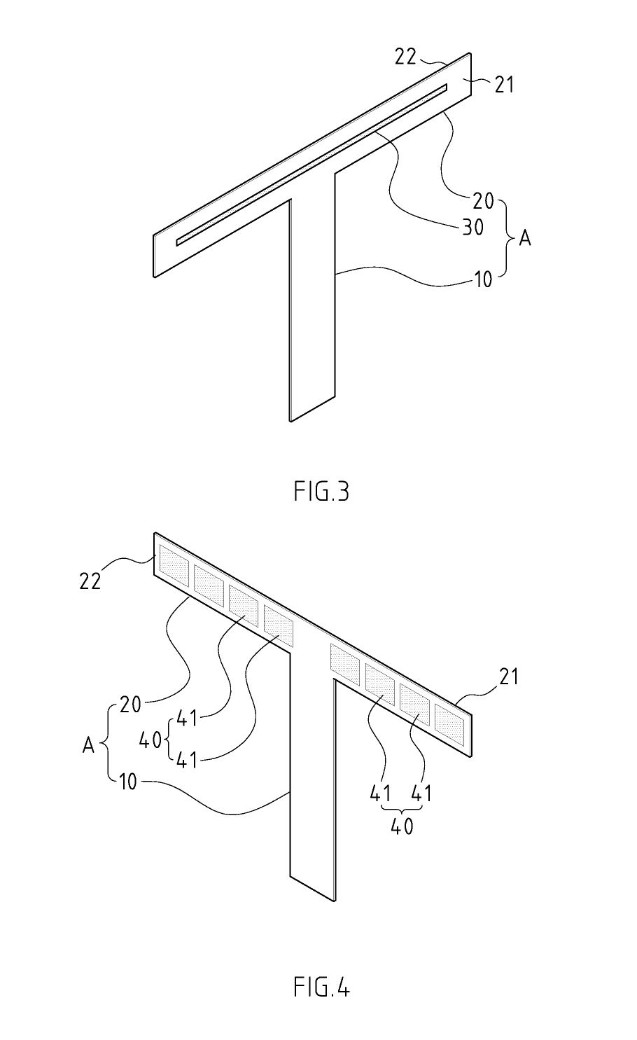

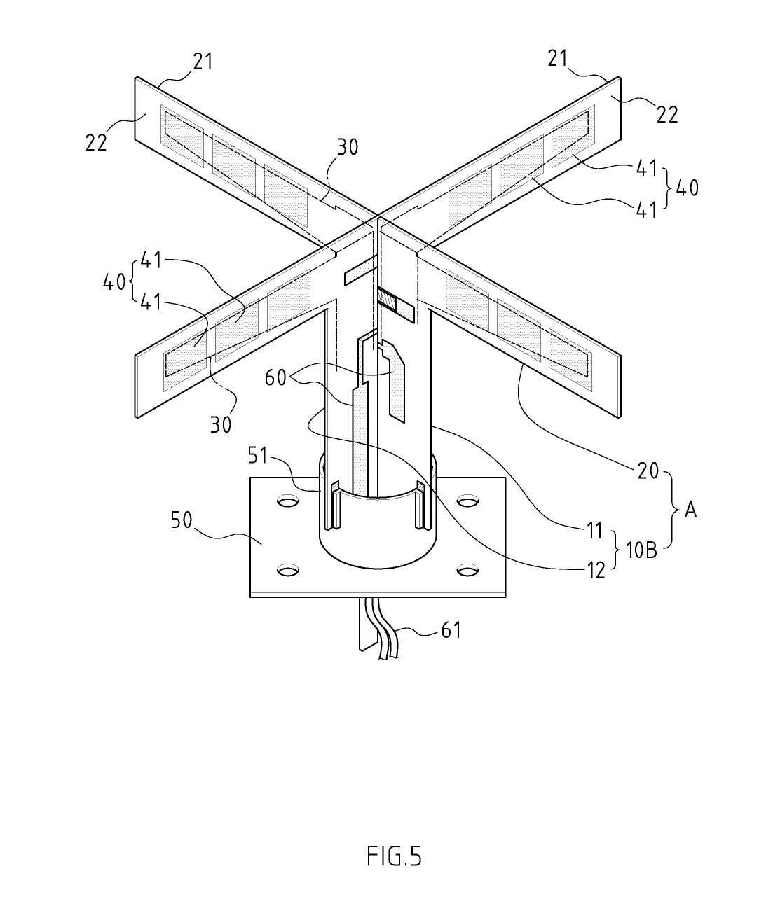

Referring to FIGS. 3 and 4, the dipole element with group of loading metal patches comprises: at least one dielectric substrate 10, in the shape of a plate; at least one resonant arm 20, configured on the upper section of the dielectric substrate 10, said resonant arm 20 being in a laterally extending form, said resonant arm 20 comprising a first side 21 and a second side 22; at least one continuous metal strip 30, configured on the first side 21 of the resonant arm 20; at least one group of metal patches 40, configured on the second side 22 of the resonant arm 20, comprising a plurality of loading metal patches 41 arranged at intervals. The straight length between the two ends of the loading metal patch 41 relatively away from each other ranges from 0.1 to 0.35 times of the wave length corresponding to the highest operating frequency of the antenna (e.g., 2690 MHZ) (note: this function is to discontinue the induced current of the high-frequency signal on the resonant arm, so as to reduce the interaction impact of diffraction or resonance), and in arrangement of their relative positions, the loading metal patch 41 and the continuous metal strip 30 at least partially overlap; and wherein, the distance between the continuous metal strip 30 and the loading metal patch 41 can not be smaller than the thickness of the dielectric substrate 10.

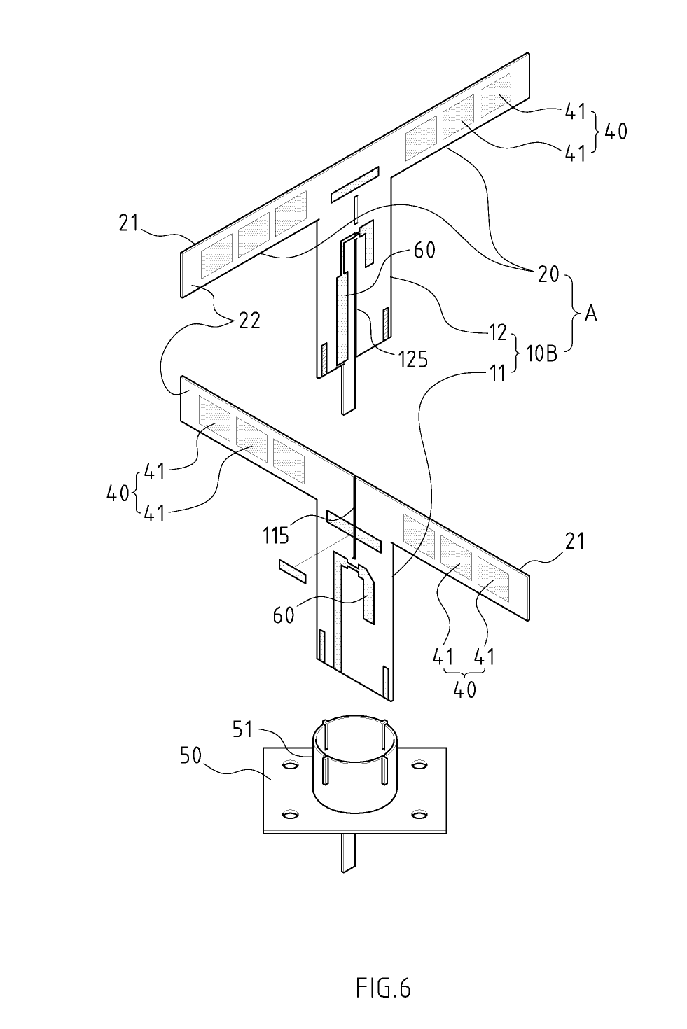

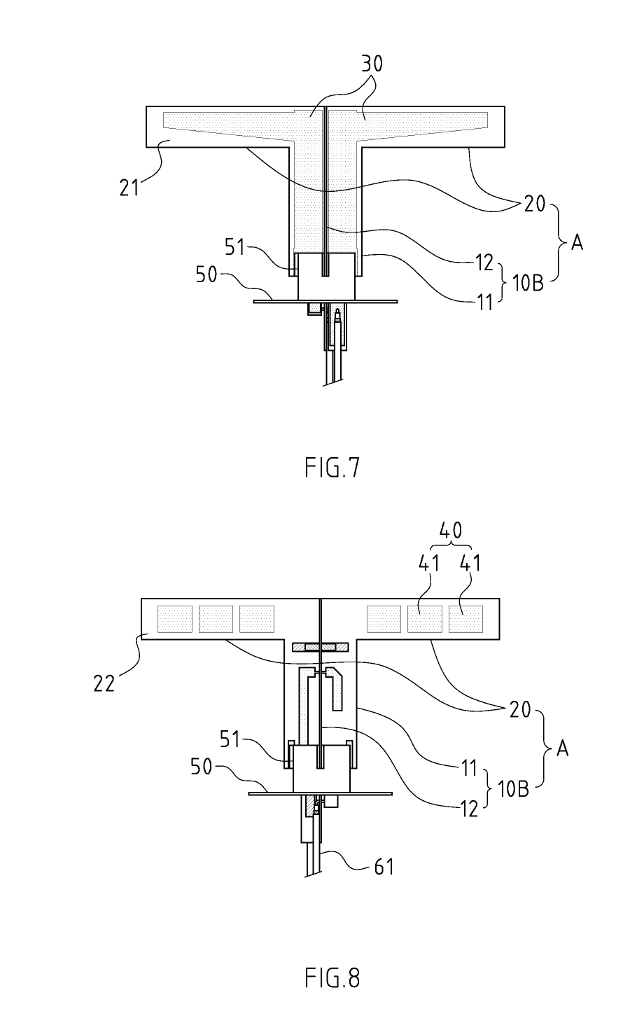

Referring to FIGS. 5 to 8, the dielectric substrate 10B can also include an X plane plate 11 and a Y plane plate 12 arranged to cross each other (in this embodiment, they cross each other perpendicularly), said X plane plate 11 and Y plane plate 12 being respectively provided with slots 115, 125 (only marked in FIG. 6) to plug into each other, so that the X plane plate 11 and Y plane plate 12 can be combined through a joggle joint. Furthermore, the upper sections of the X plane plate 11 and Y plane plate 12 are respectively provided with a resonant arm 20 to form a dual-polarization radiator. The radiator structure disclosed in the present embodiment mainly adopts a planar dipole antenna frame, with the configuration of a planar dipole antenna respectively on the two plates arranged to cross each other, and each providing a polarization.

Still referring to FIGS. 5 to 8, the lower ends of the X plane plate 11 and Y plane plate 12 can be further arranged with a carrier plate 50, and the carrier plate 50 is provided with a connecting ring 51 for the lower ends of the X plane plate 11 and Y plane plate 12 to plug into to form a fixed and supported condition. The carrier plate 50 disclosed in the present embodiment can be installed on one reflector plate 71 (see FIGS. 1 and 2), and can also provide extra short circuit points.

Particularly, the continuous metal strip 30 and group of loading metal patch 40 can be arranged as a single row (as shown in FIGS. 3 to 8), or as shown in FIG. 9, as a plurality of rows; particularly, in the case of an arrangement as a plurality of rows, the bigger size can help obtain better radiation property, but the interference with the high-frequency field pattern is also more serious.

Particularly, the resonant arm 20 can be in a vertical arrangement (as shown in FIGS. 3 to 8), or in a horizontal arrangement, like the resonant arm 20B shown in FIG. 10. Both arrangements can be implemented for the resonant arm.

Particularly, the distance between the continuous metal strip 30 and the loading metal patch 41 can range from 0.5 mm to 3.5 mm.

Particularly, the straight length between the two ends of the loading metal patch 41 relatively away from each other is 0.2 times of the wave length corresponding to the highest operating frequency of the antenna. This is a preferred embodiment, but the present invention is not limited to this.

We claim:

1. An antenna device, comprising:
a reflector plate; at least one antenna array unit distributed and arranged on the reflector plate;
at least one dipole element with a group of loading metal patches, configured on the reflector plate, spaced from the antenna array unit;
said dipole element comprising: at least one dielectric substrate, in the shape of a plate; at least one resonant arm, configured on the upper section of the dielectric substrate, said resonant arm being in a laterally extending form, said resonant arm comprising a first side and a second side;
at least one continuous metal strip, configured on the first side of the resonant arm;
at least one group of loading metal patches, configured on the second side of the resonant arm, comprising a plurality of loading metal patches arranged at intervals; the straight length between the two ends of the loading metal patch relatively away from each other ranges from 0.1 to 0.35 times of the wave length corresponding to the highest operating frequency of the antenna, and in arrangement of their relative positions, the loading metal patch and the continuous metal strip at least partially overlap; and wherein, the distance between the continuous metal strip and the loading metal patch cannot be smaller than the thickness of the dielectric substrate.

2. The antenna device defined in claim 1, wherein at least one antenna array unit is a high-frequency array and the dipole element is part of a low-frequency array.

3. The antenna device defined in claim 2, wherein there are a plurality of antenna array units, arranged on the reflector plate in the pattern of two spaced rows, said dipole element being configured between two columns of the antenna array unit.

4. The antenna device defined in claim 3, wherein there is a further arrangement of a plurality of antenna array units on the two sides of the reflector plate.

5. A dipole element with plate-shaped metal group load applied in antenna devices, comprising:
at least one dielectric substrate, in the shape of a plate;
at least one resonant arm, configured on an upper section of the dielectric substrate, said resonant arm being in a laterally extending form, said resonant arm comprising a first side and a second side;
at least one continuous metal strip, configured on the first side of the resonant arm;
at least one group of loading metal patches, configured on the second side of the resonant arm, comprising a plurality of loading metal patches arranged at intervals; the straight length between the two ends of the loading metal patch relatively away from each other ranges from 0.1 to 0.35 times of the wave length corresponding to the highest frequency of the antenna high frequency, and in arrangement, the loading metal patch and the continuous metal strip at least partially overlap; and wherein, the distance between the continuous metal strip and the loading metal patch cannot be smaller than the thickness of the dielectric substrate.

6. The dipole element with group of loading metal patches defined in claim 4, wherein the distance between the continuous metal strip and the loading metal ranges from 0.5 mm to 3.5 mm.

7. The dipole element with group of loading metal patches defined in claim 4, wherein the straight length between the two ends of the loading metal patch relatively away from each other is 0.2 times of the wave length corresponding to the highest operating frequency of the antenna.

8. The dipole element with plate-shaped metal group load defined in claim 6, wherein said resonant arm is parallel to the dielectric substrate.

9. The dipole element with group of loading metal patches defined in claim 7, wherein said resonant arm is parallel to the dielectric substrate.

10. The dipole element with group of loading metal patches defined in claim 6, wherein said oscillating arm is perpendicular to the dielectric substrate.

11. The dipole element with group of loading metal patches defined in claim 7, wherein said resonant arm is perpendicular to the dielectric substrate.

12. The dipole element with group of loading metal patches defined in claim 5, wherein said dielectric substrate comprises an X plane plate and a Y plane plate arranged to cross each other, said X plane plate and Y plane plate being respectively provided with slots to plug into each other, so that the X plane plate and Y plane plate can be combined through a joggle joint; the upper sections of the X plane plate and Y plane plate are respectively provided with an resonant arm to form a dual-polarization radiator.

13. The dipole element with group of loading metal patches defined in claim 12, wherein the lower ends of the X plane plate and Y plane plate are further arranged with a carrier plate, and the carrier plate is provided with a connecting ring for the lower ends of the X plane plate and Y plane plate to plug into to form a fixed and supported condition.
